(19) United States
(12) Patent Application Publication
(10) Pub. No.: US 2011/0095222 A1
(43) Pub. Date: Apr. 28, 2011

(54) Method for the production of valve seats, and valve

(76) Inventors: Gerhard Flores, Ostfildern (DE); Harald Zang, Stuttgart (DE); Alexander Weber, Ostfildern (DE); Carsten Zoudlik, Frickenhausen (DE)

(21) Appl. No.: 10/563,095

(22) PCT Filed: Jun. 30, 2004
(86) PCT No.: PCT/EP04/07062

§ 371 Date: Jan. 11, 2008

(30) Foreign Application Priority Data
Jul. 1, 2003 (EP) 03014909.0

(51) Int. Cl. F16K 1/42; B21D 53/10; B24B 15/04; B24B 33/02

(52) U.S. Cl. 251/359; 29/890.122; 451/51; 451/57

(57) ABSTRACT

Disclosed is a valve comprising a valve seat, the surface of which is provided with several concentric grooves (6) with profiled elevations (7) that are embodied there between. The roughness of the valve seat surface, which is defined by the grooves and the profiled elevations, is greater than the roughness of the surface of the valve closing member while the tips of the profiled elevations (7) can be elastically deformed by the valve and form a plurality of concentric sealing surfaces when the valve is closed.

The invention concerns a valve and a method for the production of valve seats.

A valve generally comprises a valve seat which surrounds a bore hole as well as a valve closing member which, when the valve is “opened”, allows for the flow of medium through the bore hole and closes same in the “closed valve” state. Valve seats often have a conical sealing surface on which a likewise conically shaped valve needle, constituting the valve-closing member, seats over a large area. Even in the event of very precise manufacturing tolerances, good sealing performance is usually not achieved for pressures in excess of 100 bar. The reason for this is, among other things, that grinding with a grinding body exercising rotational and translational motion effects finishing. Towards this end, channels are produced which have a certain pitch. A labyrinth, communicating channel structure through which leakage can occur is thereby formed.

EP 09 55 128 B1 describes a method for the production of a sealing seat between a valve ball and a valve body having a conical valve seat. Towards this end, a valve body having a conically ground valve seat for a valve ball (valve closing member) is clamped into a rotationally driven tool holder. A cylindrical grinding stone is introduced into the tool holder for the polishing process and with an adapter which permits radial motion of the grinding stone under an addressing angle tilted by 1 to 10 degrees with respect to the rotational axis, as a result of which, as seen in longitudinal section, a circular arc shaped valve seating surface is processed into the conical valve seat. This method leads to a sunken seating surface into which the sealing ball seats. Line contacts should be avoided. Towards this end, the contact surface is relatively large. The partial surfaces of the ball that contact the sealing surface have a corresponding low seating pressure.

DE 197 57 117 A1 describes a method for the production of a valve seating body for fuel injection valves with which the valve seating region and the guiding sections are simultaneously processed by a working tool in the form of a master ball. A line shaped sealing surface for seating the ball is effected in that the valve seat has a narrow enlargement which projects past the surrounding surface by approximately 0.1 mm. This procedure requires expensive processing steps and, in the event that the protrusion is damaged to even a slight extent, perhaps through interaction with a very small metal particles, the valve leaks. DE 44 41 623 describes a method for the grinding of conical valve seats with which the through bore is honed and then serves for guiding the tool for honing the conical valve seat.

Further conventional methods for the processing of valve surfaces or valves are known in the art from US 59 54 312 A, US 2002/00 40 523 A1 and DE 100 46 304 C1.

It is the underlying purpose of the invention to create a valve having improved sealing properties and to present improved methods for the production of valve seats of this kind. In particular, a creeping through the processed channels of the medium to be sealed should be prevented to improve the sealing properties.

This purpose is achieved by a valve having the features of claim 1 and by a method having the features of claim 12.

The plurality of concentric raised structures in the valve seating surface provided in accordance with the invention undergo elastic deformation when loaded by the valve closing member, since the roughness depth of the valve closing member is substantially less than that of the valve seating surface. This elastic deformation leads to narrow concentric valve seating surfaces, which substantially reduce leakage caused by creeping of the medium along the processing grooves of the valve seat so that any residual leakage remains in an acceptable region. The above-mentioned raised structures are thereby created by the method in accordance with the invention.

Substantial advantages thereby result, among others, for fuel injection pumps for engines. In a housing for fuel injection pumps having a plurality of valve seats, sealing with respect to a system pressure of in excess of 2000 bar is the critical parameter. The sealing performance is generally defined as the amount of leakage per unit time under a particular operating conditions, such as pressure, temperature and density of the medium.

Use of a ball as the valve-closing member in accordance with the invention leads to a seating along the plurality of concentric, narrow and therefore essentially line shaped sealing surfaces. Very large surface pressures and therefore large elastic deformations of the individual raised structures of the valve seat on which the ball seats thereby occur. This is geometrically permitted by the very high rounding requirements of the ball, of less than 1.0 μm. Within this tolerance, the elasticity of the raised structures can compensate for possible macro-shaped tolerances in roundness.

The described and claimed method leads to concentric processing grooves in the valve-seating surface, which have the same propagation direction as the seating circles of the ball. The processing grooves as well as their intermediate profiled raised structures are generated during honing and have no pitch relative to the line shaped sealing surface of the ball or of the valve sealing member on the valve sealing surface. Leakage currents cannot travel through spiral shaped channels. For the leak-proof character, the concentricity of the raised structures and a high roundness for the ball as well as elastic deformation of the raised structures of the valve seat are all important.

In accordance with a preferred improvement of the invention, the honing is carried out in a plurality of sequential operations. This has the advantage that each operation permits adjusted operating conditions, i.e. differing working tools. Towards this end, it is particularly advantageous when each operation removes the roughness profile of the preceding honing operation using a tool having finer cutting grit. Moreover, it is advantageous when the tool is periodically removed from engagement in order to apply cooling and lubricating medium to the processing location and to clean off residual, removed material. This leads to a particularly effective cooling and lubrication of the processing region.

It has turned out to be advantageous when, in adjusting to the appropriate working conditions, differing rates of rotation for the tool are used. During honing operations, the tool can be driven at a rate of 500 to 6000 revolutions per minute. Following the honing, burr removal can be performed, in particular, using diamond splint tools or brushes containing cutting grit. In order to effect desired honing of the initially basically conical shaped valve, the preparation procedures are advantageously carried out in such a fashion that, in the finishing step, an axial amount of valve seat material of approximately 50 μm to 90 μm is removed. The axial feed should completely remove the previously generated structures.

During polishing, it the axis of the rotating spindle of the processing machine may not be perfectly aligned with the axis of the valve seat. It therefore has turned out to be advantageous when the head of the working tool can be bent relative to the working tool holder during polishing or honing. The bending can be effected by pivoting of the tool about a pivot location in the tool holder or through elastic deformation of the tool shaft. During honing of the tool, the tool and the work piece can advantageously be driven in opposite directions with respect to each other in order to increase the processing speed.

Embodiments of the invention will be now to be described in a more detailed fashion with respect to the drawing.

FIG. 1 shows a schematic representation of a valve;

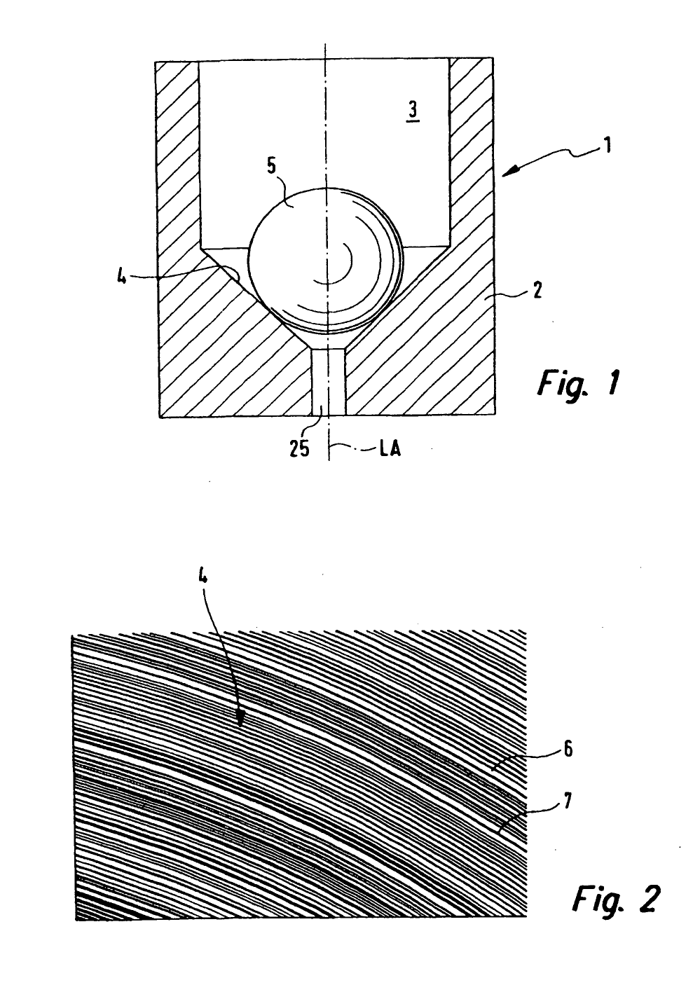

FIG. 2 shows an enlarged view of a seating surface to be processed;

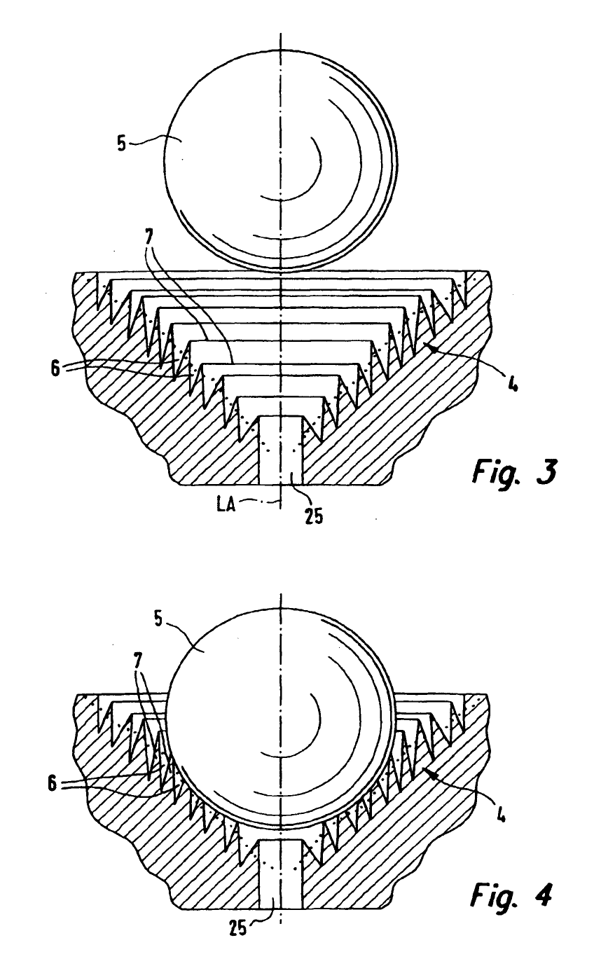

FIG. 3 is a systematic representation of a cut through a valve seat with a ball as a valve-closing member in the open state;

FIG. 4 is a representation in accordance with FIG. 3, in the closed state;

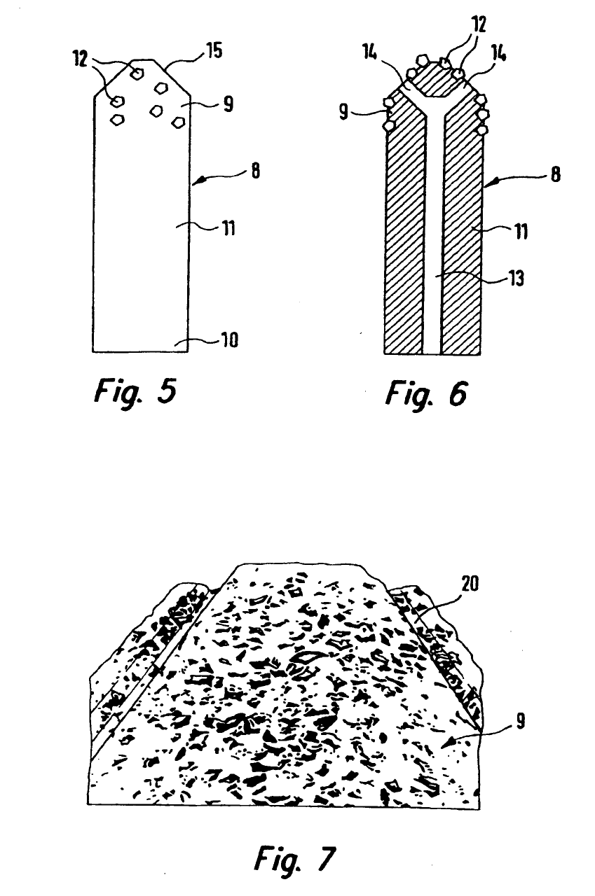

FIG. 5 is a side view of a tool having a conical working surface;

FIG. 6 is a cut through the tool in accordance with FIG. 5;

FIG. 7 is an enlarged representation of a portion of the working surface on the tool in accordance with FIG. 5;

FIG. 8 shows the structure of a multiple layered grinding body, soldered in high vacuum;

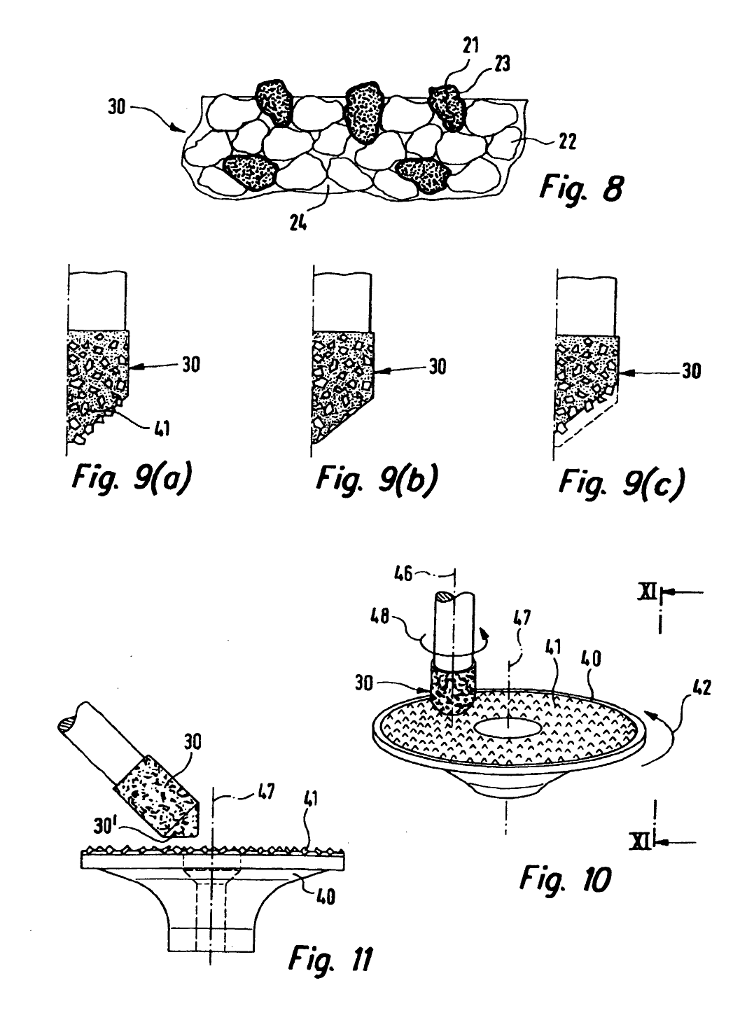

FIGS. 9a, 9b, and 9c show a multi-layered grinding body in schematic representation having ceramic or metallic bound layers in a sharpened state prior to wear (FIG. 9a), in a worn state (FIG. 9b), and in a newly sharpened state effected by tool dressing (FIG. 9c);

FIG. 10 is a perspective view of a dressing procedure with which a worn, multi-layered grinding body is dressed by a dressing wheel;

FIG. 11 is a view in the direction of arrow XI-XI of FIG. 10;

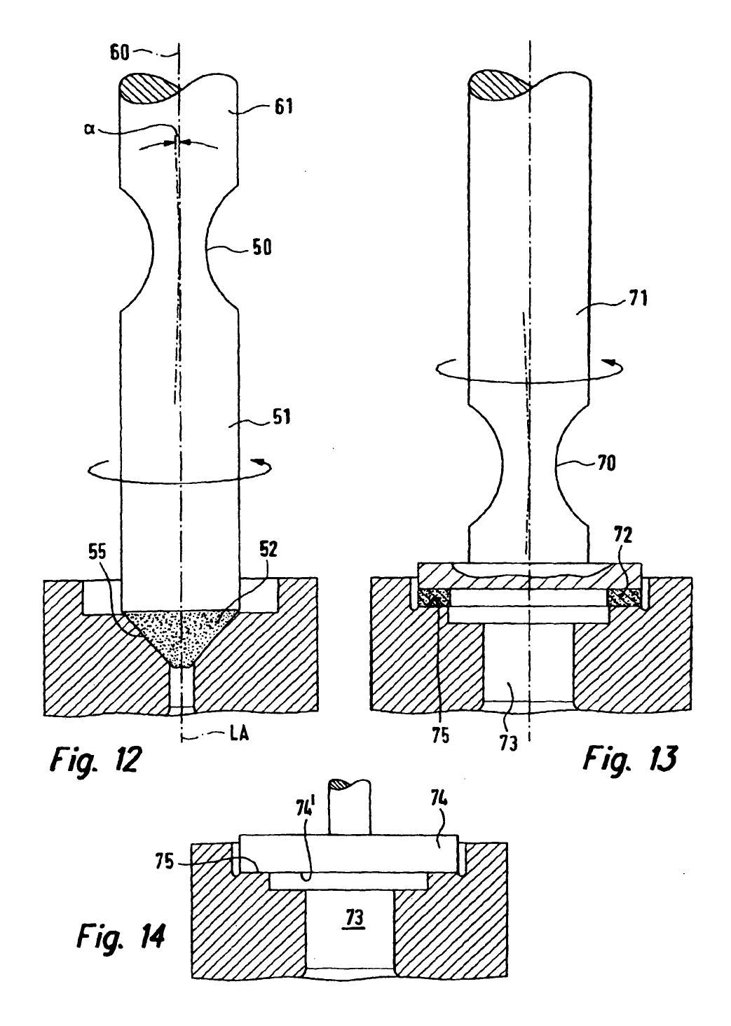

FIG. 12 shows a tool having an elastic joint location in the tool shaft;

FIG. 13 is a schematic representation of a tool for the processing of a flat sealing surface; and

FIG. 14 is a valve having a sealing surface prepared in accordance with FIG. 14.

FIG. 1 shows a schematic representation of a longitudinal cut through a valve 1. The valve consists essentially of a housing 2 in which a valve chamber 3 is formed. The valve chamber 3 is defined at one side thereof by a conical valve seat 4, wherein, in the embodiment shown in FIG. 1, the cone angle is 90 degrees. A through-hole 25 is located in the middle of the valve seat 4. Clearly, other conical angles, deviating from that of FIG. 1, can be used (see also the embodiment of FIG. 13). A valve-closing member 5 is disposed in the valve chamber 3, which, in the present case, is a ball. The ball is disposed in the valve chamber 3 in a movable fashion and can be lifted up from the valve seat 4 to open the valve 1. The representation of FIG. 1 shows the valve in a closed state. The reference signal LA designates the longitudinal axis of the borehole 25.

FIG. 2 shows an enlarged representation of a surface of the valve seat 4, processed by honing, wherein a plurality of circular shaped channels 6 and raised structures 7 are visible, which, in their totality are, circular in shape and concentric. The concentricity is relative to the longitudinal axis LA of the valve 1. The channels 6 and raised structures 7 occur during finishing by honing; wherein use is made of precisely the fact that honing produces such raised structures disposed between the channels. The roundness of the conical valve seat subsequent to honing is 1.0 μm or less.

A schematic representation of the valve seat 4 with channels 6 and raised structures 7 is given in longitudinal cut in FIG. 3. The ball serving as a valve-closing member 5 is located at a separation with respect to the valve seat 4 so that the valve is opened. The valve seat 4 has a plurality of channels 6 and raised structures 7 which are concentric with respect to the longitudinal axis LA. They have a certain depth roughness that, among other things, is given by the fact that the raised structures 7 have varying heights. The roughness R_{z} of the processed surface of the valve seat 4 following honing assumes values of e.g. 4 to 8 μm. The roughness of the valve seat must be sufficiently large than elastic deformation of the raised peaks is possible which, as described below, leads to improved sealing of the seated valve closing member and compensates for roundness tolerances. In FIGS. 3 and 4, the roughness R_{z} of the ball constituting the valve-closing member 5 must be much smaller than the roughness of the surface of the valve seat 4 and assumes values of approximately 1 μm R_{z}.

FIG. 4 shows the configuration according to FIG. 3, however, in the closed state of the valve, i.e. the valve-closing member 5 is pressed against the valve seat 4. Towards this end, the surface of ball 5, having a lower peak to valley height than that of the valve seat 4, seats on a plurality of raised structures 7. Five of such raised structures 7 are shown in a seating situation of this embodiment. This seating on a plurality of raised structures 7 is facilitated by the fact that these structures have certain elasticity and are deformed within their elastic region in response to the force exercised by the ball 5. In this manner, a plurality of concentric seals is produced leading to a very high sealing quality as well as a very low leakage rate. Creeping of the medium through the channels from the inner towards the outer region in consequence of chaotic or spiral shaped disposition of the grooves 6 is no longer possible.

FIG. 5 shows a tool 8 for finishing the valve seat 4. The method steps of finishing include a honing process which will be described in greater detail, below. The tool 8 has a tool head 9 and a tool grip 10, wherein the latter is disposed on the end of a tool shaft 11 opposite to the tool head 9. The tool head 9 has a conical surface envelope 15 with the shape of the cone corresponding to that of the valve seat 4. The tool head 9 has cutting grit 12. Convention cutting grit from diamond, cubic boron nitrite, silicon carbide or aluminum oxide can be used. The envelope lines of the conical working surface can be straight (as shown in FIG. 5) convex or concave. Convex curved contours of the envelope lines allow for the reduction of burr formation at the edges of the seating surfaces. The protrusion of the granular structures, i.e. the height with which the cutting grit protrudes beyond the surrounding binding material, is dimensioned in such a fashion that the depths of the channels 6 in the valve seat lead to raised structures 7 between respective channels 6 which undergo elastic deformation during contact with the valve closing member 5 such that the above described sealing and also compensation for roundness tolerances is achieved.

FIG. 6 shows a longitudinal cut through the tool 8 showing a channel 13 for cooling and/or lubricating media, which is located in the body of the tool as well as a plurality of openings 14 in the region of the conical surface 15.

FIG. 7 shows an enlarged representation of a section of the conical working surface 15 of the conical tool 18. As can be clearly seen, a plurality of cutting grit elements 12 are embedded in the outer side. Longitudinal slots 20 are also visible which serve for the supply of cooling and lubricating medium to the working area.

The valve seat 4 is first prepared, for example hardened or machined. The machining processing following the hardening can be skipped in the event that hardening distortions are minimal. Subsequent thereto, finishing is carried out with the assistance of the tool 8 shown in FIGS. 5 through 7. The dynamics of the procedure include rotation of the tool while applying the working surface 15 of the tool to the conical surface constituting the valve seat 14 following processing.

The tool 8 is moved in the axial direction in correspondence with material removal. Towards this end, it is advantageous to periodically remove the tool from engagement with the working area for cooling, rinsing, and lubrication purposes. A positioning device for the tool that controls both the path and the amount of applied force does this. The axial positioning force of the tool is controlled in a fashion appropriate to the process, and the amount of material removal is also monitored. Spring-loaded application of the tool is also, in principle, possible. The finishing of the piece is carried out in a plurality of operations by honing the conical seat. In each operation, the shape and the roughness profile from the previous honing operation is completely removed using finer cutting grit. The final operation creates the final surface shape mentioned above. The processing steps correct irregularities created by preceding steps, thereby leading to successfully finer surfaces. In response to these dynamics, the concentric channels 6 shown in FIGS. 2 through 4 are created, as are the raised structures 7 disposed between the channels. The honing operation is followed by grit removal using, for example, diamond grit tools and/or brushes containing cutting grit.

An electro-magnetic controller can e.g. control the control and travel. The spindle device initially travels in rapid advance into axial proximity to the desired working position. Towards this end, the tool is located in close proximity to the work piece, with a safety separation being traversed by the spindle at reduced speed. As soon as the tool seats on the working surface of the work piece, the axial seating force is increased to the desired working force. This position is set to “0” and the tool is set into rotation so that the working mode begins. The removal in the axial direction during a working operation should be performed with predetermined cycle times. The control device registers the amount of the material removed as well as the time required therefor and/or the working speed. In the event that an amount of material removal is not achieved in the desired time, the force is automatically increased during operation of the next work piece.

The method described above facilitates creation of valve seating surfaces with good sealing properties, in consequence of the topography of the roughness profile and due to the extremely precise tolerances with respect to the roundness of the valve seat 4.

In principle, as is usually the case with honing, a single diamond cutting layer or a cBN cutting layer (cBN=cubic boron nitrite) can be utilized. Both are built up using galvanic binding. The grinding mechanism of such a single galvanic cutting layer is effected by projection of the cutting crystals out of a nickel matrix in such a fashion as to effect material removal on the work piece. This, however, has the associated disadvantage that the cutting crystals become worn with increasing use. For this reason, the introductory pressure must be constantly increased in order to achieve the required penetration depths. The tool is fully worn when the raised cutting crystals are substantially worn away.

In the event of a plurality of grinding layers, the cutting crystals are disposed in a three dimensional fashion within a binding matrix. One is usually dealing with sintered or bonded mechanisms produced by high vacuum soldering (HVS) involving metallic bonding with diamonds or cBN grit. FIG. 8 shows the structure of such a HVS grinding tool 30 having cutting crystals 21, mineral filling particles 22, solder connections 23, and a metallic binding phase 24, for example, silver solder.

Due to the circulating cutting track defined by the tool dynamics, no self-sharpening occurs during grinding, unless the direction of rotation is changed. In the event of a multi-layered structure, one must push back the bonding medium by dressing at regular intervals. FIG. 9a shows a cutting tool that is not yet been worn out and FIG. 9b shows a worn out cutting tool, which must be dressed.

FIGS. 10 and 11 show a dressing procedure of this kind. Towards this end, a dressing wheel 40 is provided having embedded diamond crystals 41. The dressing wheel 40 is turned in the direction of arrow 42 by means of a drive device (not shown).

During dressing, the axis of rotation 46 of the cutting body 30, having a cutting layer 41, is slanted relative to the axis of rotation 47 of the dressing wheel 40 in correspondence with the desired conical angle of the tool. As indicated by arrow 48, the cutting body 30 is rotated in such a fashion that its conical covering 30′ moves opposite to the direction of motion of the dressing wheel 40 at the point of their mutual engagement. FIG. 9c shows the dressed and thereby newly sharpened cutting body 40 (the original contour is indicated with dashed lines).

With cutting tools made from diamond or cBN and having a plurality of layers, ceramic dressing wheels 40 are used having a grain size which is smaller than the grain size of the tool and with a cutting velocity of 1 to 3 m/s. Ceramically bound silicon carbide or aluminous tools are, in contrast thereto, dressed using a diamond wheel having a grain size of D181 to D426.

FIG. 12 shows a tool for the processing of conically shaped valve seats 55 which, in consequence of imperfect production, still have a remaining deviation between the axis LA of the valve seat 55 and the rotational axis 60, of an angle α. The axis of rotation 60 is the axis about which the tool 51, which is clamped at end 61 in a tool clamp (not shown), is rotated. In order to compensate for the tilted position α, the tool 51 has a flexible joint 50, effected by a tapered portion, which allows adjustment of the cutting body 52 to the valve seat during rotation. The angle α is normally in the range of a few angular minutes. This can be compensated for through elastic bending at such an intended bending location.

FIG. 13 shows an additional embodiment with which the tool 71 has a bending joint 70 that is introduced at the lower end of a cutting body 72. This particular embodiment is further distinguished in that the area of the valve seat 75, which surrounds the channel 73, is flat. In this case, concentric grooves or channels are also produced with intermediate raised structures which are suitable, in the event of seating with a valve closing member 74 having a flat surface, to deform elastically, thereby forming concentric, essentially line-shaped sealing surfaces. For proper functioning of the valve, it is important that the tool cover the entire valve seating surface and, in contrast to grinding, with no advanced motion parallel to the valve seating surface being processed, since that would prevent concentric channels and associated raised structures from being produced.

In correspondence with the deflection relationships, the flat tool in accordance with FIG. 13 has a bending joint 70 which is as downwardly disposed as possible, whereas, in the event of the tools having a conical cutting body, for example according to FIG. 12, the bending joint 70 is disposed as high up as possible, since such tools are deflected by a horizontal normal force.

1-22. (canceled)

23. A valve, the valve comprising:
a valve closing member; and
a valve seat having a bore hole for a medium to be controlled, a surface of said valve seat having a plurality of concentrically extending channels and elevated structures disposed between said channels, wherein a roughness of said valve seat surface, defined by said channels and said elevated structures, is larger than a roughness of a surface of said valve closing member, wherein peaks of said elevated structures are elastically deformed when the valve is closed to define a plurality of concentrically extending sealing surfaces.

24. The valve of claim 23, wherein said roughness of said valve seat surface is <8 μm.

25. The valve of claim 23, wherein said roughness of said valve seat surface is approximately 1 μm.

26. The valve of claim 23, wherein said valve seat surface has a tapered, conical form.

27. The valve of the claim 23, wherein said channels and said elevated structures on said valve seat surface are produced by honing without advance parallel to said valve seat surface.

28. The valve of claim 23, wherein, during honing, a surface of a honing tool covers an entire portion of said valve seat surface coming in contact with said valve closing member when the valve is closed.

29. The valve of claim 23, wherein said valve-closing member is a ball.

30. The valve of claim 23, wherein said valve closing member has a flat sealing surface.

31. The valve of claim 26, wherein a precision of roundness of said elevated structures and of said channels (6) is ≦2.0 μm.

32. The valve of claim 30, wherein a tolerance in a precision of flatness of said elevated structures is <4 μm.

33. A method for production of a valve seat having a valve seating surface which cooperates with a valve closing member, the method comprising the step of:
finishing the surface with a honing process using a tool having a tool head cooperating with the valve seating surface, the tool being driven to rotate and produce concentrically extending working channels on the valve seating surface by means of cutting grit disposed on the tool head, wherein an amount by which the cutting grit protrudes from a surface of the tool head is defined to produce the working channels on the valve seating surface, the working channels having a depth which is sufficiently large to permit elastic deformation of elevated structures disposed between the channels in response to seating of a valve closing member on the valve seating surface, thereby forming a plurality of narrow, concentric sealing surfaces.

34. The method of claim 33, wherein the valve seat has a nominal conical shape initially effected in pre-finish processing steps and, in a finishing step, the valve seat is conically shaped a honing process, the honing process being carried out using a tool having a tool head filling a conical shape, and with means for introducing cooling and lubricating materials, the tool being driven to rotate and, by means of cutting grit located on the tool head, produce processing channels which are disposed concentrically about the conical shape on the valve seating surface, wherein a protrusion of grains on the tool head is dimensioned in such a fashion that a peak to valley depth of the channels is sufficiently large to permit elastic deformation of elevated structures between the channels to compensate for tolerances in roundness.

35. The method of claim 33, wherein the honing is carried out in at least two sequential operations.

36. The method of claim 35, wherein, in each honing operation, a roughness profile of a previous honing operation is abrasively removed using a tool having finer cutting grit.

37. The method of claim 33, wherein the tool is periodically removed from working engagement and a processing location is subjected to flow of a cooling and lubricating medium.

38. The method of claim 33, wherein during honing, the tool rotates at a rate of 250 to 6000 revolutions per minute.

39. The method of claim 33, wherein, subsequent to honing, a grit removal process is carried out or a grit removal process is carried out using diamond tipped tools and/or brushes having cutting grit.

40. The method of claim 33, wherein, during finishing, an axial amount of material on the valve seat of approximately 20 μm to 90 μm is removed.

41. The method of claim 33, wherein the tool is deflected during the honing process by means of a bending joint fashioned in its shaft to compensate for misalignment of a longitudinal axis of the valve seat.

42. The method of claim 41, wherein said bending joint is effected through lubrication of a tool shaft, a deflection being effected through elastic deformation of the bending joint.

43. The method of claim 33, wherein a working tool and a work piece are driven in opposite directions during honing.

44. The method of claim 33, wherein a tool having a plurality of layers is utilized with which a cutting grit is ceramically bonded, wherein the tool is dressed by a flat dressing wheel with respect to whose surface, the tool is tilted through an angle in correspondence with a desired conical shape of the work piece, wherein the tool and the dressing wheel are driven in opposite directions during dressing of the tool.
